(19) United States
(12) Patent Application Publication
(10) Pub. No.: US 2008/0132291 A1
(43) Pub. Date: Jun. 5, 2008

(54) ON DEMAND RADIO ACCESS TECHNOLOGY SELECTION

(76) Inventors: John R. Barr, Deer Park, IL (US); Raymond B. Essick, Glen Ellyn, IL (US)

Correspondence Address: MOTOROLA INC, 600 NORTH US HIGHWAY 45, W4 - 39Q, LIBERTYVILLE, IL, 60048-5343, US

(21) Appl. No.: 11/565,288

(22) Filed: Nov. 30, 2006

(51) Int. Cl. H04B 1/38

(52) U.S. Cl. 455/567

(57) ABSTRACT

System and method for receiving a call in a wireless device. A notification message is received over a first radio access technology (RAT) that another wireless device wants to engage in the call. At least one other RAT is identified that can be utilized to connect the call. The at least one other RAT is selected to connect the call. A connection is initiated through utilization of the at least one other RAT.

### FIELD

The present application relates generally to radio access technology (RAT) and more specifically to wireless devices that engage in calls over RAT networks.

### BACKGROUND

There are many different Radio Access Technologies (RATs) available to users of wireless devices. Understandably, users of wireless devices would like the flexibility to utilize as many RATs as possible. Therefore, manufacturers often provide wireless devices with the capability of connecting to multiple RATs. These wireless devices continually monitor their surroundings to determine what RATs are available. The user of the wireless devices, or the device itself, can then select an optimum RAT when making a call. This flexibility, however, comes with a cost because continual monitoring for multiple RATs increases power consumption and decreases battery life.

Accordingly, what is needed is an approach that provides the flexibility to utilize different RATs without accompanying cost in power consumption. What is needed is on demand RAT selection.

### SUMMARY

In one example, a method for receiving a call in a wireless device is provided. A notification message is received over a first radio access technology (RAT) that another wireless device wants to engage in the call. At least one other RAT is identified that can be utilized to connect the call. The at least one other RAT is selected to connect the call. A connection is initiated through utilization of the at least one other RAT.

In one example, a method is provided. A call connection request is received, from a first communication device, to engage in a call with a second communication device. It is determined whether or not the second communication device is registered to receive calls. A call notification is generated if the second communication device is registered to receive calls. The call notification is sent to the first communication device over a wireless communication network that is designated for providing call notifications.

### BRIEF DESCRIPTION OF THE DRAWINGS

For the purpose of facilitating an understanding of the subject matter sought to be protected, there are illustrative embodiments in the accompanying drawing, from an inspection of which, when considered in connection with the following description and claims, the subject matter sought to be protected, its construction and operation, and many of its advantages should be readily understood and appreciated

FIG. 1 depicts an exemplary system, including a plurality of call initiating devices and a call recipient device connected to two exchange servers, by which the recipient device associates with a RAT.

FIG. 2 is a descriptive diagram outlining an exemplary process in which the call recipient of FIG. 1 performs RAT selection after receiving notification of a call from a call initiating device.

FIG. 3 is a flowchart providing a more detailed illustration of the process of FIG. 2.

FIG. 4 is illustrates an exemplary embodiment of the process of FIGS. 2 and 3 in which a call notification includes the location of an RAT network for the recipient device of FIG. 1.

### DETAILED DESCRIPTION

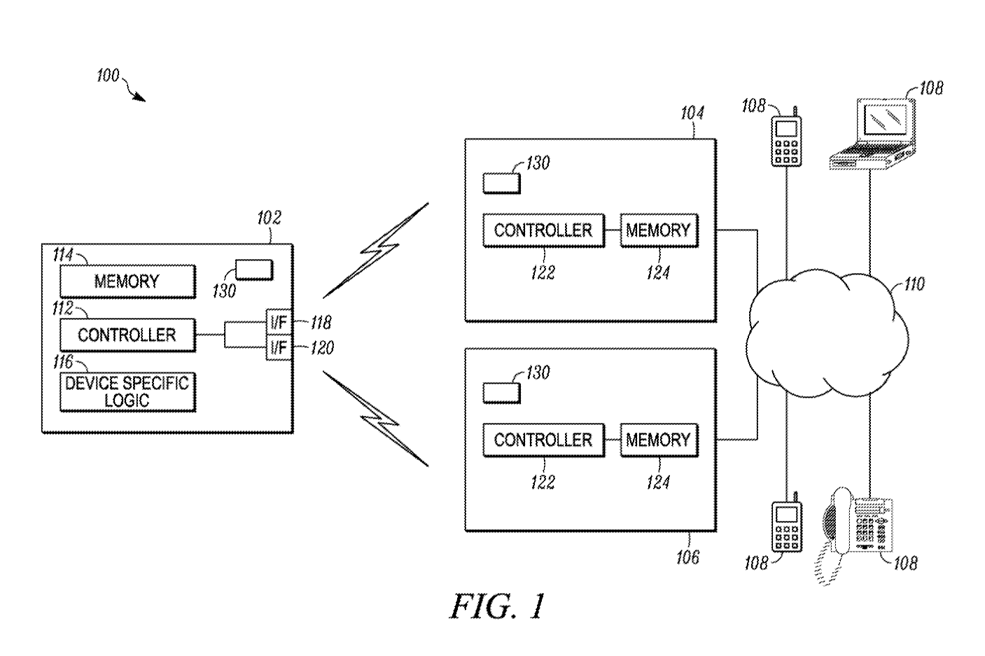

Referring to FIG. 1, an exemplary system 100 is shown for illustrative purposes. System 100 in one example comprises a recipient wireless device 102, two instances of server 104, 106 and a plurality of call initiating devices 108.

Recipient device 102 in one example is connected to each of servers 104, 106 through a Radio Access Technology (RAT) or a combination of RATs. Examples include but are not limited to GSM, GPRS, CDMA, IDEN, 2.5G, 3G, WiMAX (802.16e), Bluetooth, WiFi (802.11), etc. Examples of recipient device 102, include but are not limited to, cellular phones, mobile phones, pagers, radios, personal digital assistants (PDAs), mobile data terminals, laptop computers, application specific gaming devices, video gaming devices incorporating wireless modems, and combinations or subcombinations of these devices.

The general design and operation of these devices is well known so a detailed description of each possible embodiment will be omitted. Nevertheless, for illustrative purposes, recipient device 102 is shown to include exemplary components, such as a controller 112, memory 114, device specific logic 116, and interfaces 118, 120, that will help to explain the claimed subject matter.

Controller 112 is the processor that governs and carries out the device specific functionality of the recipient device 102. In one example, controller also initiates scanning for available RATs in response to call notification and executes processes to select an optimum RAT.

Memory 114 provides storage in which data, instructions, software routines, code sets, databases, etc. can be stored. Device specific logic 116 refers to components of recipient device that, not explicitly mentioned herein, that are necessary for it to perform in its intended way. For example, if recipient device 102 were a mobile phone, device specific logic 116 would include components such as a user interface, a display, etc. Interfaces 118, 120, in one example, are wireless devices that provide the necessary functionality to allow recipient device to connect to the networks of which servers 104, 106 are part. For instance, if server 104 were an enterprise server on a wide area paging network, interface 118 would provide the various components (e.g. hardware and software) that device 102 would employ to connect to the wide area paging network. If server 106 were an enterprise server in a GSM network, then interface 120 would provide the components that device 102 would employ to connect to the GSM network. For ease of explanation, wireless device is shown having two interfaces, but it will be understood that wireless device could have more than two interfaces.

Servers 104, 106 in one example are enterprise servers that are each a component of a network that utilize one of the aforementioned RATs. Recipient device 102 in one example registers with each of the servers 104,106 such that the network to which each server belongs can provide service to recipient device 102. The general design and operation of such servers are known so a detailed description of each possible embodiment will be omitted. Nevertheless, to effectively illustrate the principles of operation set forth herein, servers 104,106 are shown to include exemplary components, such as a controller 122 and memory 124.

Controller 122 is the processor that governs each server 104,106 and executes its core functionality. Each controller 122 in one example is configured to determine whether recipient device 102 is registered to its corresponding network. Memory 124 provides storage in which data, instructions, software routines, code sets, databases, etc. can be stored. In one example, each memory 124 includes a database that includes the identity of each device that is registered to its corresponding network.

Servers 104,106 are connected to call initiating devices 108 through network 110. Network 110 can be any network that allows call initiating device 108 to communicate with servers 104 and to each other (e.g., a Local Area Network (“LAN”), a telephone network, a Wide Area Network (“WAN”), a wireless LAN, a wireless WAN, the Internet, a wireless telephone network, etc.). Network 110 can also be a combination or a sub combination of the above recited networks. Moreover, it is possible that some devices 108 could communicate with each or to servers 104 directly while others communicate over the network 20. The general design and operation of various networks are known so a detailed description of each possible embodiment has been omitted. For instance, it will be understood that servers 104, 106 will not necessarily be connected directly to network 110, but that other network provider equipment, such as network bridges, gateways, and the like might be present. Furthermore, it will be understood that servers 104, 106 will not necessarily connect directly to recipient device 102, but connected to recipient device through a wireless transmitter, such as a mobile network base station. Nevertheless, to effectively illustrate the principles of operation set forth herein, the preceding components have been depicted in the drawings.

Exemplary devices 108 include, but are not limited to, personal computers, laptops, personal digital assistants (“PDA”), a mobile telephones, landline telephones, media servers, media players, workstations, file servers, mainframes, and so on. A device 108 can also be a subcombination of, a removable component of, or a combination of the aforementioned devices. The devices 108 each include one or more communication interfaces, which can be land based (e.g., T1, DSL, Cable, POTS) or wireless (e.g. Bluetooth, IrDA, WiFi, etc.) The communications links between devices 108 and network 110 can either be secure or non-secure.

It will be appreciated that the preceding description has been provided for illustrative purposes only. The aspects of system 100 shown in FIG. 1 have been provided to effectively illustrate the claimed subject matter. Recipient device 102, servers 104, 106, and call initiating devices 108 are formed from computer software and/or hardware components. A number of such components can be combined or divided. In one example, an exemplary component of each device employs and/or comprises a series of computer instructions written in or implemented with any of a number of programming languages, as will be appreciated by those skilled in the art. Accordingly, it will be apparent that parts could be added or subtracted from system 100 without departing from the inventive concepts set forth herein.

Further, the terms “recipient device 102” and “call initiating device 108” have been chosen as useful descriptors when describing on demand RAT selection. However, recipient device 102 and call initiating devices 108 are bi-directional devices. Therefore, recipient device 102 does not just receive calls, but also initiates calls and call initiating device 108 do not only initiate calls, but also receives calls.

Also, it will be recognized that in a wireless communication system there can be multiple devices. Therefore, there could be more than one recipient device 102 connected to each server 104, 106.

Finally, recipient device 102 and servers 104, 106 each employ at least one computer-readable signal-bearing medium 130. An example of a computer-readable signal-bearing medium 130 is a recordable data storage medium such as a magnetic, optical, and/or atomic scale data storage medium. In another example, a computer-readable signal-bearing medium is a modulated carrier signal transmitted over a network coupled to recipient device 102 or servers 104, 106. Computer-readable signal-bearing medium 130 in one example stores software and/or logic components that are employable to carry out functionality described herein.

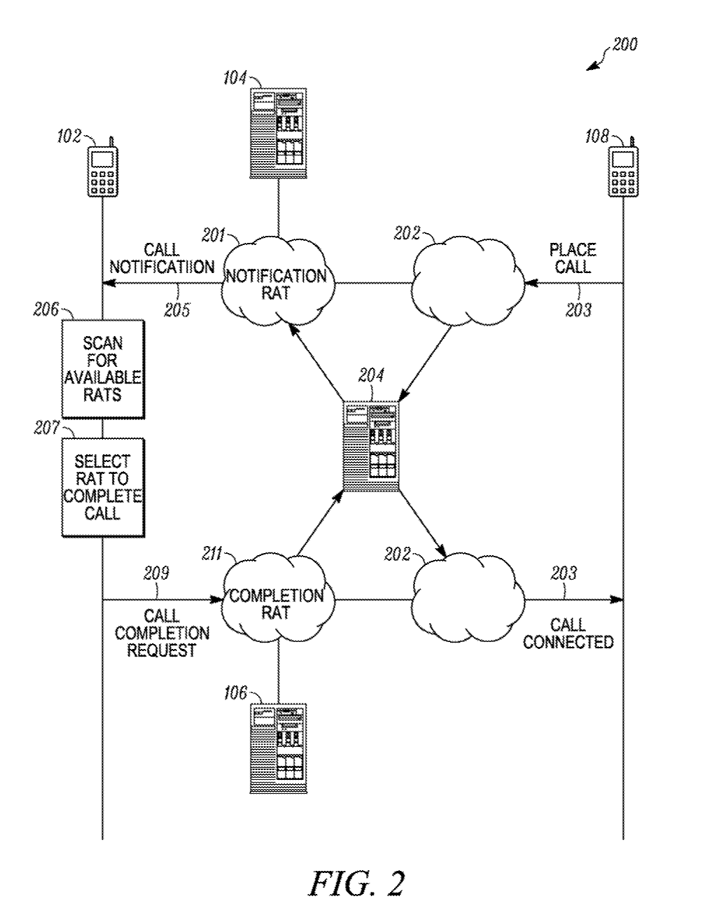

Referring to FIG. 2, an exemplary description of on demand RAT selection will now be described for illustrative purposes.

In FIG. 2, recipient device 102 is registered with server 104. Server 104 is part of a RAT network 201, which will be referred to as the Notification RAT 201. In one example, the Notification RAT 201 is a wide area paging network. In another example, the Notification RAT 201 is any network, which is sufficient to provide call notifications to recipient device when a call is initiated to it. For example, the Notification RAT 201 could be any of the wireless devices described in conjunction with FIG. 1. In a further example, the Notification RAT 201 could also be wired network if desirable. In yet another example, the Notification RAT 201 could be a combination of networks. Finally, it should be understood that recipient device 102 could also register with multiple Notification RATs.

Initiating device 108 is also connected to a network 202. Network 202 could be one of any of the previously mentioned networks. Network 202 could also be a combination of these networks. Network 202 allows initiating device 108 to place calls to other devices including device 101. Network 202 could be the same network as notification RAT 201; however, if network 202 were different than notification RAT 201, it should be understood that network 202 would include the necessary hardware (e.g. interfaces, gateways, switching equipment, etc.) and software to allow network 202 to connect to notification RAT 201.

When an initiating device 108 places a call 203 to recipient device 102, the call is routed through one or more networks until it is received by enterprise server 104 on Notification RAT 201. The manner by which enterprise server receives notification of the call depends on the type of network on which device 108 resides. In one example, if network 202 and notification RAT 201 were the same network, a local exchange service on network 201/202 would locate enterprise server 104 without reference to another network. In another example, if network 202 were distinct from network 201, network 202 accesses a global exchange server 204 which has information regarding the location of devices on both networks 201, 202. Exchange server 204 looks up the enterprise server 104 of recipient device 102 and notifies it that device 108 placed a call to recipient device 102.

Enterprise server 104 then determines whether or not recipient device 102 is registered to receive calls. If recipient device 102 is registered to receive calls, then server 104 sends a call notification message 205 to recipient device 102 over notification 201. Recipient device 102 then in step 206 scans for available RATs to employ in completing the call. If one or more RATs are available and the user of device 102 wants to complete the call, then device 102 (or user) selects in step 207 a RAT to complete the call. Recipient device 102 sends a call completion request 209 to enterprise server 106, which is part of a network 211 which will be referred to as the Completion RAT, i.e. the RAT that the user selects to complete the call. Enterprise server 106 then accesses global exchange server 204 to locate call initiator 208. Alternatively, if completion RAT 211 were the same as network 203, a local exchange server could be utilized to locate call initiator. Global exchange server then notifies network 203 that recipient device 102 wants to complete the call, and network 203 then takes the steps necessary to connect the call 213 to call initiator 108.

Referring to FIGS. 1-3, a more detailed description 300 of the process by which recipient device performs on demand RAT selection is now provided for illustrative purposes. In step 301, controller 112 of recipient device 102 places all interfaces other than interface 118 (e.g. interface 120), which it uses to connect to call notification RAT 201, in “off” or low power mode. In one example, this involves controller powering off interface 120. In another example, this means interface 120 is only drawing minimal power such that it can be activated in a short period of time. In a further example, this means that controller periodically activates interface 120 such that it can scan for available RATs.

In step 303, device 102 registers with server 104. In one example, controller 112 creates a registration message and sends it to sever 104. Accordingly, server 104 is made aware that recipient device 102 is available to take calls. In a further example, recipient device 102 registers with multiple servers (not shown) to receive call notification messages. Such an approach would improve the coverage of system 100. As another alternative, recipient device 102 could register with server 104 prior to placing interfaces, other than interface 118, in low power or “off” mode.

In step 305, a call initiating device 108 initiates a call to recipient device 102. In one example, this is a voice call sent through one or more networks. In another example, it could be a call to establish a data connection. In a further example, it could be a combination voice and data call.

In step 307, enterprise server 104 receives the call or notification of the call. In step 309, the server 104 determines whether recipient device 102 is receiving calls. In one example, controller 122 accesses memory 124 to determine whether recipient device 102 is registered and whether device 102 is accepting calls. If the recipient device is not registered or not accepting calls, then in step 311, enterprise server 104 sends a message to call initiating device 108 indicating that a call cannot be completed to device 102. If the recipient device 102 is registered and receiving calls, then controller 122 of server 104 will generate a call notification message and send it to recipient device in step 313. The call notification message can take many different forms.

For instance, the call notification message could include preferences that the operator of Notification RAT 201 wishes that recipient device 102 would use to complete the call. For instance, the operator might prefer, given the circumstances, that recipient device use Notification RAT 201 to complete the connection, or the operator might prefer that the recipient device use a particular technology, such as WiFi, to complete the call. In another instance, the server 104 might know the location of recipient device, through GPS or other means, and know what RATs are available in that location. The notification could include this information, thereby providing recipient device 102 with a head start with respect to identifying available RATs. In a further instance, the call notification could include caller identification information. In another instance, the call notification could provide recipient device with the type of call. In a further instance, the call notification could include the cost involved with connecting to the available RATs.

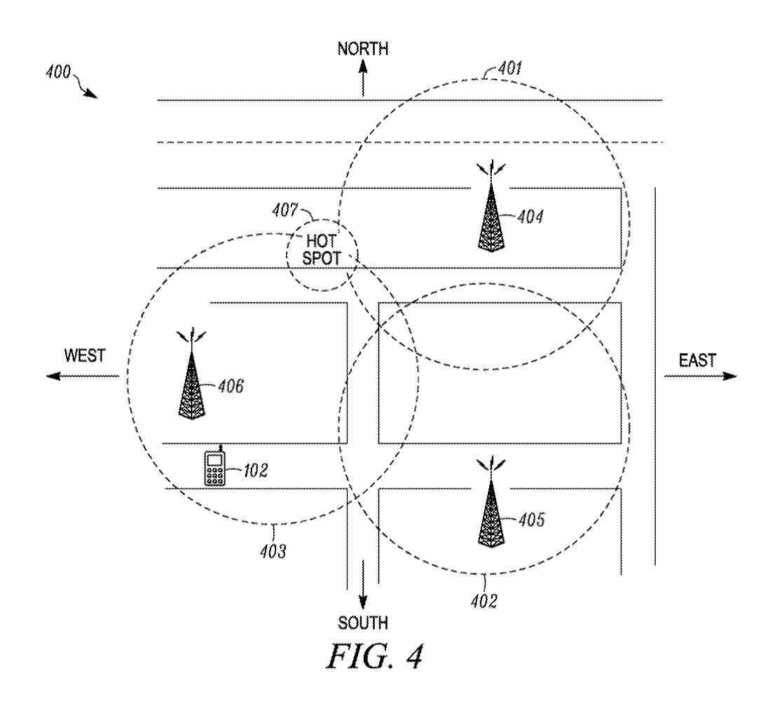

Referring to FIG. 4, an instance is shown in which recipient device 102 is in a network coverage area 400. Network coverage area is shown as comprising 3 cells 401, 402, 403. Each cell 401, 402, 403 is served by a corresponding base station 404, 405, 406. Recipient device is located in cell 401 and is in communication with base station 406. A WiFi “Hot Spot” coverage area 407 s located between coverage areas 401, 403, Northeast of recipient device 102. In the example, network 400 is the Notification RAT. If enterprise server connected to the network 400 is aware of recipient device's 102 location, then the notification message could include recipient device's 102 location and the location of WiFi Hot Spot 407. Recipient device 102 could then travel to coverage area 407 to complete the call. In another example, the call notification message could include the identity of a preferred WiFi provider and the location of the provider's access points. In another example, if recipient device 102 were in an area of overlapping WiFi Hot Spots or in an area in which connection with multiple WiFi Hot Spots was possible, the call notification could include preferred network information and/or quick connection/authentication information to allow recipient device 102 to quickly establish a connection.

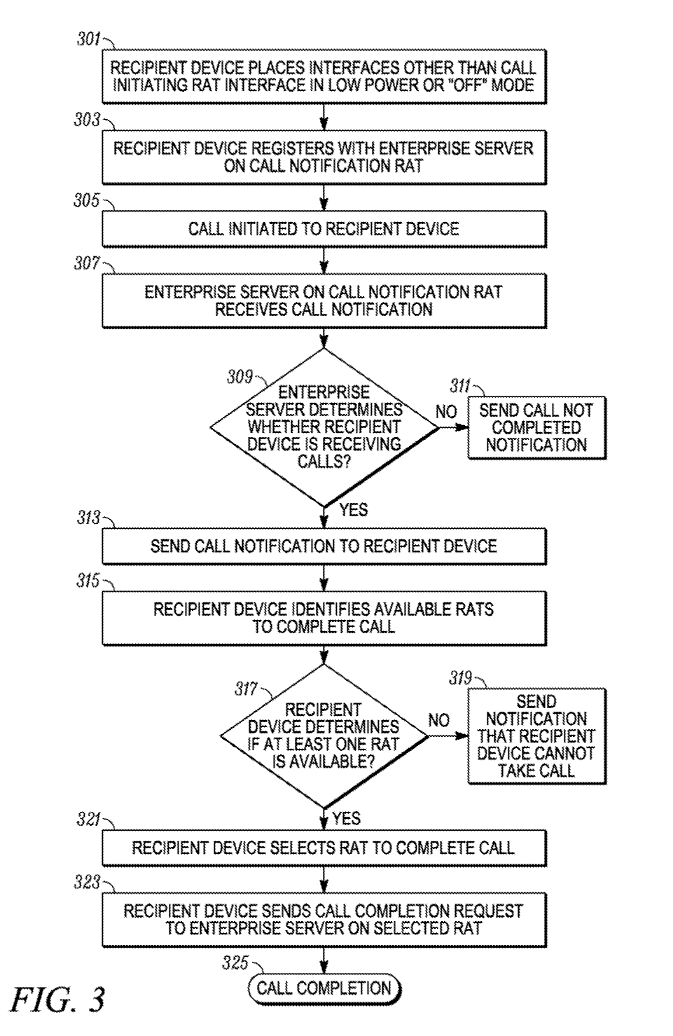

Referring now to FIG. 3, once recipient device 102 receives the call notification, the controller 112 of recipient device 102 will, in step 315, initiate identification of available RATs for completing the call. In one example, the controller 1 12 identifies available RATs by activating interface 120, and any other interfaces present on the device, to scan for signals from various RATs. In another example, the controller 112 utilizes information in the call notification (e.g. WiFi locations) to determine available RATs. In another example, the memory 114 may contain previously acquired information about available RATs relative to current position of recipient device 102.

In step 317 recipient device 102 will determine if at least one RAT is available to complete the call. If no, then in step 327 a message is sent notifying server 104 that the call cannot be completed. If yes, then in step 321, the recipient device 102 will select a RAT for call completion. In one example, the selection is performed by controller 112 in accordance with some predetermined criteria (e.g. quality of service, data rate, low power consumption, etc.) In another example, the selection of a RAT is pushed on recipient device by the notification message. In a further example, the user of recipient device is prompted through the user interface in device specific logic 116 to select a RAT to complete the call.

In step 323, the recipient device will send a registration message to an enterprise server on the Completion RAT. Then in step 325, the enterprise server will initiate completion of the call between initiating device 108 and recipient device 102.

While particular embodiments have been shown and described, it will be apparent to those skilled in the art that changes and modifications may be made without departing from the principles set forth herein. The matter set forth in the foregoing description and accompanying drawings is offered by way of illustration only and not as a limitation.

1. A method for receiving a call in a wireless device, comprising:
receiving a notification message over a first radio access technology (RAT) that another wireless device wants to engage in the call;
identifying at least one other RAT that can be utilized to connect the call;
selecting the at least one other RAT to connect the call; and
initiating connection of the call through utilization of the at least one other RAT.

2. The method of claim 1, further comprising:
registering with a wide area paging network.

3. The method of claim 2, wherein the step of receiving the notification message comprises:
receiving a page over the wide area paging network.

4. The method of claim 1, wherein the step of receiving the notification message comprises:
receiving information that identifies the at least one other wireless RAT.

5. The method of claim 4, wherein the step of identifying comprises:
identifying the at least one other RAT from the notification message.

6. The method of claim 1, further comprising:
scanning for available RATs that can be used to connect the call.

7. The method of claim 1, wherein the step of receiving the notification message comprises:
receiving at least one of an identification of the at least one other RAT, a location of an access point for the at least one other RAT, caller identification (ID) information, a location of the wireless device, a cost function of completing the call, and a data type to be exchanged during the call.

8. The method of claim 7, further comprising:
selecting criteria to employ when selecting the at least one other RAT.

9. The method of claim 8, wherein the step of selecting the at least one other RAT comprises:
employing the criteria in conjunction with information contained in the notification message to choose the at least one other RAT.

10. The method of claim 1, wherein the step of receiving the notification message comprises:
receiving preference information, from an operator of the wireless communication network, which identifies a preferred RAT for completing the call.

11. The method of claim 1, wherein the step of selecting the at least one other RAT comprises selecting a wireless local area network.

12. The method of claim 1, wherein the step of initiating connection comprises:
sending a call completion request to an exchange server on a wireless communication network.

13. A method, comprising:
receiving a call connection request, from a first communication device, to engage in a call with a second communication device;
determining whether or not the second communication device is registered to receive calls;
generating a call notification if the second communication device is registered to receive calls; and
sending the call notification to the first communication device over a wireless communication network that is dedicated to providing call notifications.

14. The method of claim 13, wherein the step of sending the call notification comprises:
sending a page to the second communication device over a wide area paging network.

15. The method of claim 13, wherein the step of generating the call notification comprises:
including, in the call notification, at least one of an identification of at least one other wireless communication network that can be utilized to connect the call, a location of an access point for the at least one other wireless communication network, caller identification (ID) information, a location of the second communication device, a cost function of completing the call, and a data type to be exchanged during the call.

16. The method of claim 13, wherein the step of generating the call notification comprises:
providing preference information in the call notification, which indicates a preferred wireless communication network for the second communication device to utilize when completing the call.

17. The method of claim 16, further comprising:
determining the location of the second communication device; and
employing the location of the second communication device to identify the preferred wireless communication network.

18. The method of claim 17, wherein the step of employing the location comprises:
identifying a wireless local area network proximate to the second communication device.

19. The method of claim 16, further comprising:
notifying the preferred wireless communication network that the second communication device will attempt to associate with it to complete the call.

20. The method of claim 19, wherein the step of notifying comprises:
providing the wireless local area network with a MAC address and authentication information for the second communication device.
